(19) United States
(12) Patent Application Publication
(10) Pub. No.: US 2024/0396246 A1
(43) Pub. Date: Nov. 28, 2024

(54) ELECTRICAL CONNECTOR WITH IMPROVED HIGH FREQUENCY PERFORMANCE

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventor: HONG-JING LUO, Shenzhen (CN)

(21) Appl. No.: 18/673,945

(22) Filed: May 24, 2024

(30) Foreign Application Priority Data
May 25, 2023 (CN) 202310598193.4

(51) Int. Cl. H01R 13/424; H01R 12/72; H01R 13/502; H01R 13/6471

(52) U.S. Cl. CPC H01R 13/424; H01R 12/721; H01R 13/502; H01R 13/6471

(57) ABSTRACT

An electrical connector includes: a longitudinal inner insulator and two rows of terminals retained in the inner insulator along a longitudinal direction with two ends of each terminal extending out of the inner insulator; and an insulator frame receiving the inner insulator and having a longitudinal mating slot and plural terminal grooves distributed at two sides of the mating slot, the terminals being received in corresponding terminal grooves and each having a contacting portion bent into the mating slot, wherein the inner insulator has a through-slot, the through-slot penetrates the inner insulator along the longitudinal direction and is located between the two rows of terminals.

### BACKGROUND OF THE INVENTION

### Field of the Invention

The present invention relates to an electrical connector which transmits high frequency signal.

### Description of Related Arts

U.S. Publication No. 2022/0336980A discloses an electrical connector, which includes an insulative member and two terminal assemblies received in the insulative member. Each terminal assembly includes an insulator bar and a plurality of terminals retained in the insulator bar. A portion of the terminals embed in the insulator bar has a lower impedance, leading poor high frequency performance of the electrical connector.

Therefore, it is desired to provide an electrical connector with improved high frequency performance.

### SUMMARY OF THE INVENTION

An object of the present invention is to provide an electrical connector with improved high frequency performance.

To achieve the above object, an electrical connector comprises: a longitudinal inner insulator and two rows of terminals retained in the inner insulator along a longitudinal direction with two ends of each terminal extending out of the inner insulator; and an insulator frame receiving the inner insulator and having a longitudinal mating slot and plural terminal grooves distributed at two sides of the mating slot, the terminals being received in corresponding terminal grooves and each having a contacting portion bent into the mating slot, wherein the inner insulator has a through-slot, the through-slot penetrates the inner insulator along the longitudinal direction and is located between the two rows of terminals.

Other advantages and novel features of the invention will become more apparent from the following detailed description of the present embodiment when taken in conjunction with the accompanying drawings.

### BRIEF DESCRIPTION OF THE DRAWING

FIG. 1 is a perspective view of an electrical connector;

FIG. 2 is another perspective view of the electrical connector of FIG. 1;

FIG. 3 is an exploded perspective view of the electrical connector of FIG. 1;

FIG. 4 is another perspective view of the electrical connector of FIG. 3;

FIG. 5 is a perspective view of the first terminal module and the second terminal module which are separated from each other;

FIG. 6 is another perspective view of the first terminal module and the second terminal module of FIG. 5;

FIG. 7 is another perspective view of the first terminal module and the second terminal module of FIG. 4;

FIG. 8 is a partial front view of the first terminal module of FIG. 5;

and

FIG. 9 is a cross-sectional view of the electrical connector along line A-A of FIG. 1.

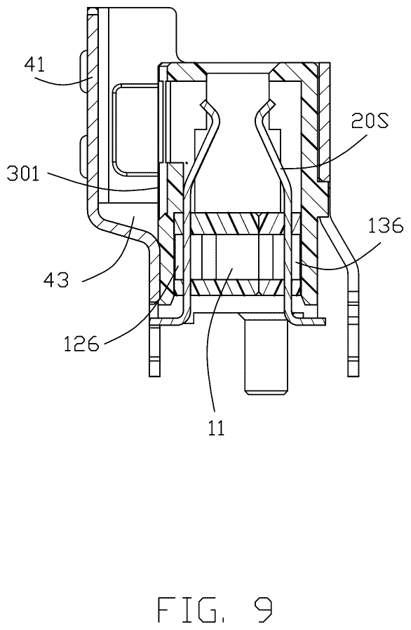

### DETAILED DESCRIPTION OF THE PREFERRED EMBODIMENT

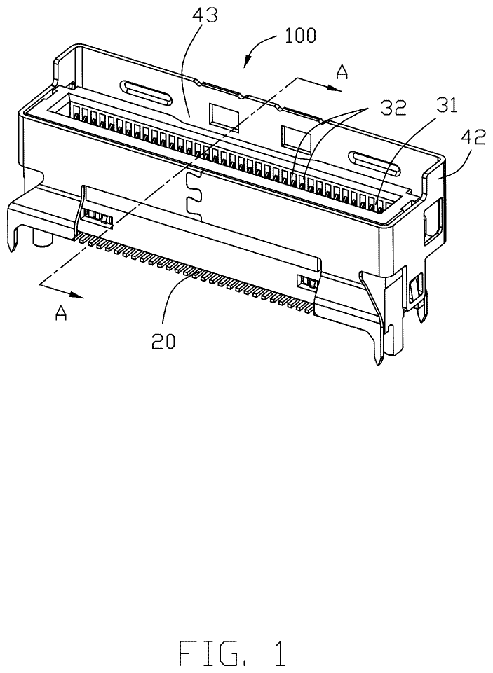

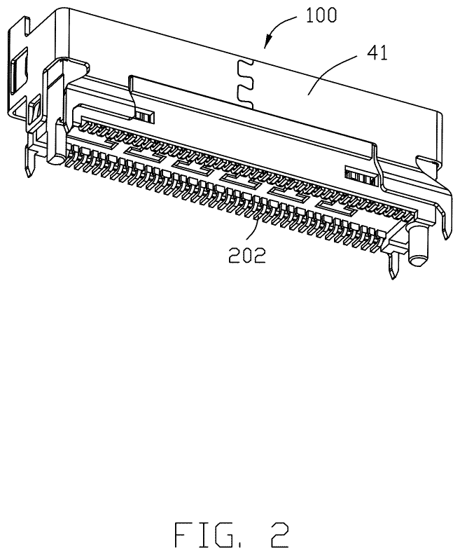

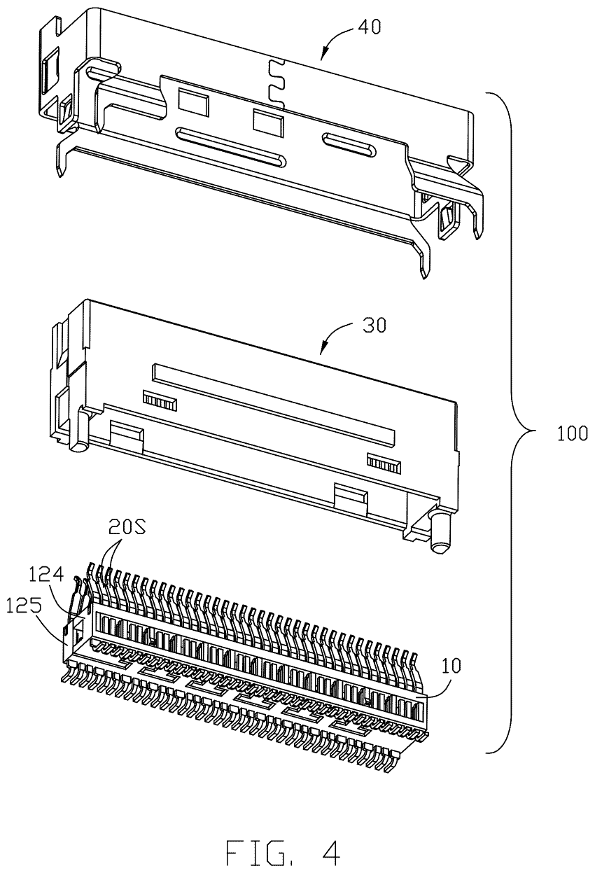

Referring to FIGS. 1-4, an electrical connector 100 for transmitting high frequency signals is illustrated. The electrical connector 100 is of a board connector with a longitudinal mating slot 31, and a mating connector which may be an inserting card or a cable connector with an inserting card which can be inserted into the mating slot 31. The connector 100 has an inner insulator 10, two rows of terminals 20, an insulator frame 30, and an outer shell 40 fixed at an outside of the insulator frame 30. The insulator frame 30 is provided with the mating slot 31 and plural terminals grooves 32 in which the terminals 20 are received. The terminals grooves 32 are distributed at two sides of the mating slot 31, thus, the terminals 20 in one row are opposite to the terminals in another row in a transverse direction perpendicular to the longitudinal direction. The inner insulator 10 has a first insulating bar 12 and a second insulating bar 13 in which the two rows of the terminals 20 are retained respectively, forming a first terminal module 120 and a second terminal module 130. Each row of terminals comprise plural signal terminals 20S and plural grounding terminals 20G and are retained in one of the two insulating bars 12, 13 with two ends of the terminals exposed to an exterior of the longitudinal bar. Each of the grounding terminals 20G and the signal terminals 20S comprises a contacting end 201 with a contacting portion 200 at one end thereof and a connecting tail 202 at another end thereof and a middle portion 203 between them. The terminals 20 are received in the corresponding terminal grooves 32 one to one respectively. The contacting portions 200 bend into the mating slot 30 for contacting with the inserting card. The connecting tails 202 extend downwardly out of the longitudinal bars and the insulator frame 30 for contacting with an electrical circuit board. The inner insulator 10 is provided with a through-slot 11 which penetrates the inner insulator 10 along the longitudinal direction and the through-slot is located between the two rows of the terminals 20. The outer shell 40 has two side plates 41 and two end plates 42, the side plates 41 are located at the corresponding outsides of two side walls 301 of the insulator frame 30 and the end plates 42 are located at the corresponding outsides of the end walls 302 of the insulator frame 30. One of the side plates 41 is spaced with the side wall 301 to form a receiving groove 43 therebetween.

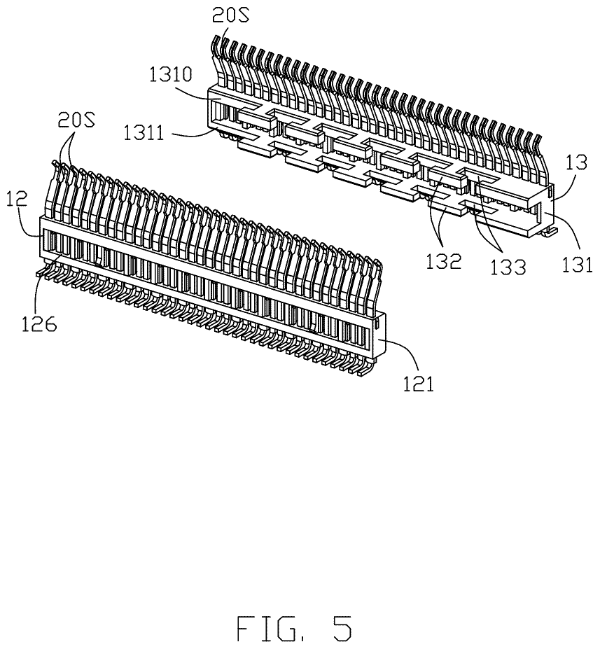

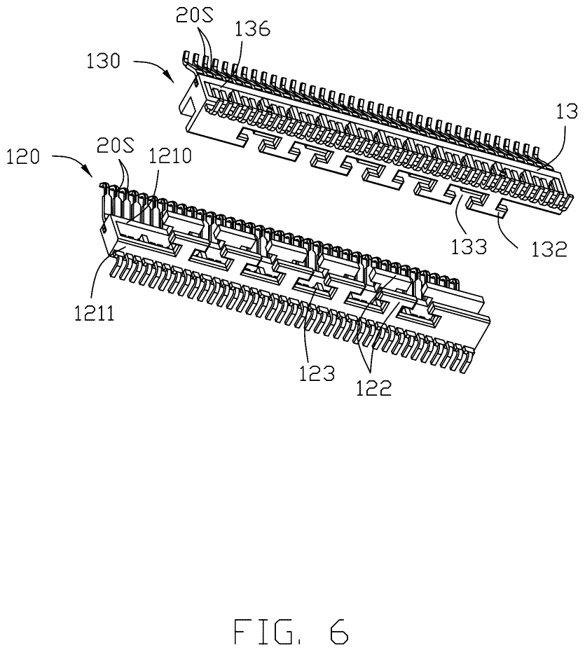

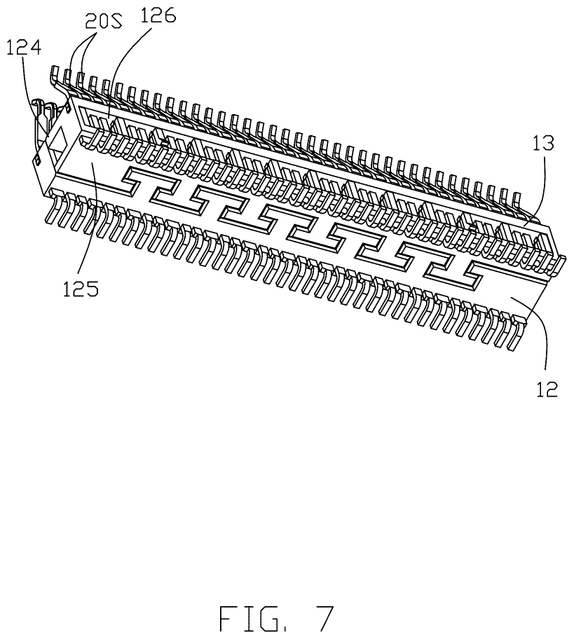

Referring to FIGS. 5-7, the first or second insulating bar 12, 13 includes a base portion 121, 131, plural locking blocks 122, 132 distributed along an upper row and a lower row, in each row, the locking blocks are spaced with each other along the longitudinal direction and form a locking groove 123, 133 therebetween, thus, first terminal module 120 and the second terminal module 130 can be locked with each other by making the locking blocks 122, 132 be locked in the locking grooves 123, 133. For better locking, the locking blocks 122, 132 of the two terminal modules 120, 130 are T-shaped except for the locking blocks 122, 132 at two ends of the two terminal modules 120, 130. In the first terminal module 120, an upper face of the locking blocks 122 in the upper row is flush with an upper face of the base portion 121, and a lower face of the locking block 122 in the lower row is flush with a lower face of the base portion 121, similar to first terminal module 120, an upper face of the locking blocks 132 in the upper row is flush with an upper face of the base portion 131, and a lower face of the locking blocks 132 in the lower row is flush with a lower face of the base portion 131. The locking blocks 122, 132 in the upper row are received in the locking grooves 123, 133 in the upper row and form an upper plate 124, the locking blocks 122, 132 in the lower row are received in the locking grooves 123, 133 in the lower row and form a lower plate 125.

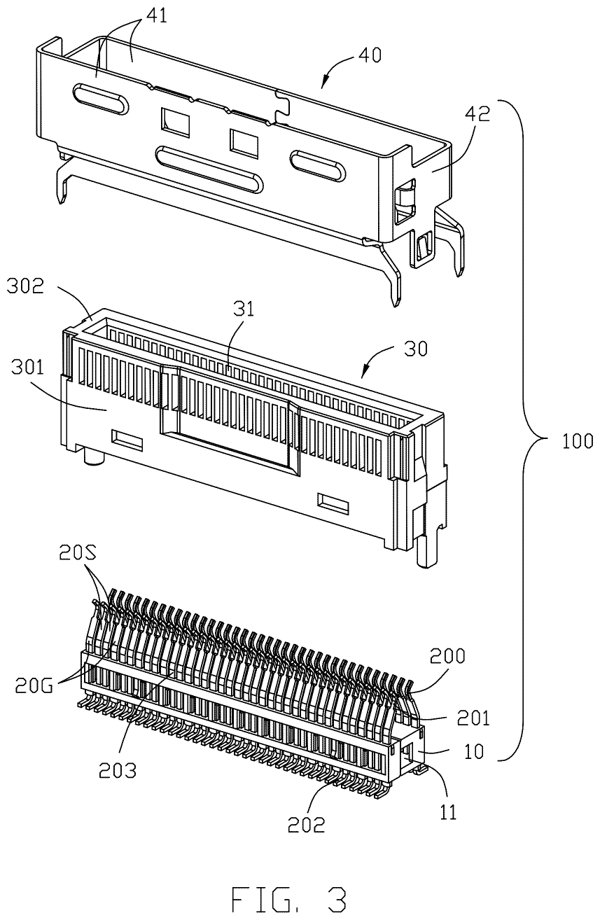

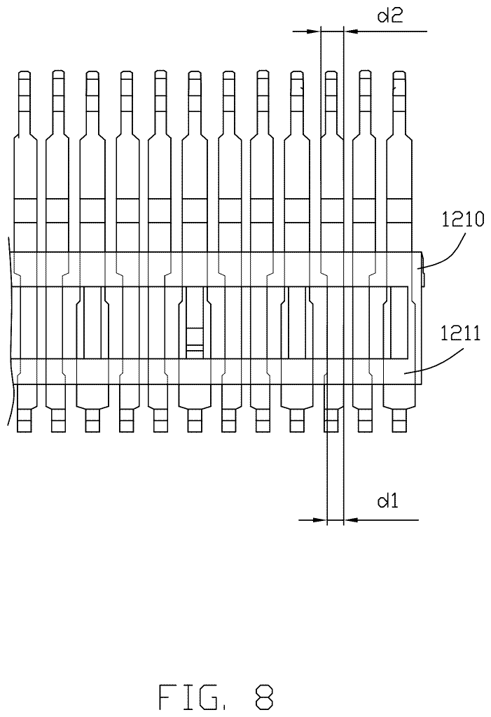

Referring to FIGS. 3-6, a cross-section of the through-slot 11 is rectangular. The through-slot 11 is located between the upper plate 124 and the lower plate 125 in an upper-lower direction and is located between the base portion 121 and the base portion 131 in the transverse direction. The signal terminals 20S in the first terminal module 120 and the second terminal module 130 are all exposed to the through-slot 11, in addition, the first insulating bar 12 is provided with plural notches 126 on its outer side away from the through-slot 11 for making the signal terminals 20S in the first terminal module 120 exposed to the notches 126. Similar to the first insulating bar, the second insulating bar 13 is provided with plural notches 136 on its outer side away from the through-slot 11 for making the signal terminals 20S in the second terminal module 130 exposed to the notches 136. In other embodiments, the notches 126 in the first insulating bar 12 penetrates the base portion 121 in the transverse direction and intercommunicates with the through-slot 11, making the signal terminals 20S exposed to the through-slot 11 inside and exposed to the notches 126 outside, and the notches 136 in the second insulating bar 13 penetrates the base portion 131 in the transverse direction and communicates with the through-slot 11, making the signal terminals 20S exposed to the through-slot 11 inside and exposed to the notches 136 outside. The base portion 121 has an upper beam 1210 over the notches 126 and a lower beam 1211 under the notches 126, the locking blocks 122 in the upper row extend from the upper beam 1210 and the locking block 122 in the lower row extends from the lower beam 1211. Similar to the first terminal module, the base portion 131 has an upper beam 1310 over the notches 136 and a lower beam 1311 under the notches 136, the locking blocks 122 in the upper row extends from the upper beam 1310 and the locking blocks 122 in the lower row extends from the lower beam 1311. Further referring to FIG. 8, a width of the middle portion 203 of the signal terminal exposed in the notches 126, 136 is d1, a width of the middle portion 203 extending out from the base portion 121, 131 is d2, and d2 is larger than d1, a transition of the middle portion from d1 to d2 is embed in the upper beam 1210, 1310 and the lower beam 1211, 1311.

Although the present invention has been described with reference to particular embodiments, it is not to be construed as being limited thereto. Various alterations and modifications can be made to the embodiments without in any way departing from the scope or spirit of the present invention as defined in the appended claims.

The invention claimed is:

1. An electrical connector comprising:
a longitudinal inner insulator and two rows of terminals retained in the inner insulator along a longitudinal direction with two ends of each terminal extending out of the inner insulator; and
an insulator frame receiving the inner insulator and having a longitudinal mating slot and plural terminal grooves distributed at two sides of the mating slot, the terminals being received in corresponding terminal grooves and each having a contacting portion bent into the mating slot;
wherein the inner insulator has a through-slot, the through-slot penetrates the inner insulator along the longitudinal direction and is located between the two rows of terminals.

2. The electrical connector as claimed in claim 1, wherein the inner insulator comprises a first insulating bar and a second insulating bar, the first insulating bar is retained with one row of the terminals to form a first terminal module, the second insulating bar is retained with the other row of terminals to form a second terminal module, and the through-slot is located between the first terminal module and the second terminal module.

3. The electrical connector as claimed in claim 2, wherein each insulating bar comprises a base portion, plural locking blocks extending from the base portion, and plural locking grooves formed between two neighboring locking blocks, the plural locking blocks of one of the two insulating bars are received and locked in the plural locking grooves of the other of the two insulating bars.

4. The electrical connector as claimed in claim 3, wherein the locking blocks are T-shaped except for the locking blocks at opposite ends of the two insulating bars.

5. The electrical connector as claimed in claim 3, wherein the locking blocks of each insulating bar are arranged in an upper row and a lower row, and the first terminal module and the second terminal module are centrally symmetrical.

6. The electrical connector as claimed in claim 5, wherein the through-slot is located between the locking blocks in the upper row and the locking blocks in the lower row in an upper-lower direction, and the through-slot is located between the base portions of the two insulating bars in a transverse direction perpendicular to the longitudinal direction, and a cross-section of the through-slot is rectangular.

7. The electrical connector as claimed in claim 3, wherein each row of the terminals comprises plural pairs of signal terminals and plural grounding terminals, and the signal terminals are exposed to the through-slot.

8. The electrical connector as claimed in claim 7, wherein each base portion of the two insulating bars has a plurality of notches on an outer side thereof away from the through slot, and the signal terminals are exposed to the notches.

9. The electrical connector as claimed in claim 5, wherein each row of the terminals comprises plural pairs of signal terminals and plural grounding terminals, plural notches are provided at an outer side of each base portion, the signal terminals are exposed to the notches, the base portion comprise an upper beam over the notches and a lower beam under the notches, the locking blocks in the upper row extend from the upper beam, and the locking blocks in the lower row extend from the lower beam.

10. The electrical connector as claimed in claim 9, wherein each terminal comprises a contacting end with the contacting portion, a tail end, and a middle portion between the contacting end and the tail end, a width of the middle portion exposed to the notches is less than a width of the middle portion outside the notches.

11. An electrical connector comprising:
an insulator frame having a mating slot;
a first terminal module having a first insulating bar and a first row of terminals retained in the first insulating bar; and
a second terminal module having a second insulating bar and a second row of terminals retained in the second insulator bar;
wherein the first terminal module and the second terminal module are assembled together and commonly received in the insulator frame; and
wherein a longitudinal through-slot is defined by the first insulating bar and the second insulating bar and signal terminals of the first row of terminals and the second row of terminals are exposed to the through-slot in a transverse direction.

12. The electrical connector as claimed in claim 11, wherein each of the first insulating bar and the second insulating bar has a vertical base portion, an upper row of locking blocks and a lower row of locking blocks extending form the base portion along the transverse direction, every two neighboring blocks of the same row are spaced by a locking groove, and the locking blocks of one of the two insulating bars are received and locked in the locking grooves of the other of the two insulating bars.

13. The electrical connector as claimed in claim 12, wherein the locking blocks of the two insulating bars in the upper row form an upper plate and the locking blocks of the two bars in the lower row form a lower plate, and the through-slot is located between the upper plate and the lower plate in an upper-lower direction and is located between the base portions of the two insulator bars in the transverse direction.

14. The electrical connector as claimed in claim 12, wherein plural notches are provided at an outer side of each base portion, and the notches extend through the base portion in the transverse direction and communicate with the through-slot to expose two sides of the signal terminals in the notches and the through-slot, respectively.

15. The electrical connector as claimed in claim 11, further comprising an outer shell, wherein the outer shell covers an outside of the insulator frame and has two longitudinal side plates, the two side plates are located at corresponding outsides of two side walls of the insulator frame, and one of the two side plates is spaced with the side wall to form a receiving groove therebetween.
